(19) United States
(12) Patent Application Publication
(10) Pub. No.: US 2008/0018993 A1
(43) Pub. Date: Jan. 24, 2008

(54) SELF-ALIGNING SCANNING PROBES FOR A SCANNING PROBE MICROSCOPE

(76) Inventors: Thomas Sulzbach, Weisendorf (DE); Manfred Detterbeck, Kreuzlingen (CH); Mathieu Burri, St. Blaise (CH); Christoph Richter, Furth (DE); Hans-Jurgen Ludge, Jena (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/750,386

(22) Filed: May 18, 2007

(30) Foreign Application Priority Data
May 26, 2006 (EP) 06010813.1

(51) Int. Cl. G02B 21/00

(52) U.S. Cl. 359/368

(57) ABSTRACT

Scanning probes are provided for alternative use in a scanning probe microscope. The scanning probes have micro cantilever beams of different lengths whose one end has a scanning tip for scanning a sample and whose other end has a holding element for the non-permanent attachment of the scanning probe to a support element secured in position on a probe holder, and where corresponding alignment elements are incorporated in the holding element and in the support element that align the holding element in automatically reproducible fashion relative to the probe holder when coupled with the support element. The distance between the scanning tip and a defined reference point of the holding element is constant in each case so that an alignment of the scanning probe in longitudinal direction is not necessary when the scanning probe is exchanged.

### PRIORITY CLAIM

This application claims priority under 35 U.S.C. §119(a) to European Patent Application No. 06010813.1, filed on May 26, 2006, the entire contents of which are hereby incorporated by reference.

### TECHNICAL FIELD OF THE INVENTION

The invention concerns scanning probes for alternative use in a scanning probe microscope where the scanning probes have a micro cantilever beam whose one end has a scanning tip for scanning a sample and whose other end has a holding element for the non-permanent attachment of the scanning probe to a support element secured to a probe holder, and where corresponding alignment elements are incorporated in the holding element and in the support element that align the holding element in automatically reproducible fashion relative to the probe holder when coupled with the support element.

### DESCRIPTION OF THE RELATED ART

Scanning probe microscopes are well known. They serve to scan the surface of a sample with resolutions down to the atomic level. For this purpose, the scanning tip—with a sharpness in the nanometer range—of a scanning probe that is attached non-permanently to the scanning head of the scanning probe microscope by means of a probe holder is guided over the surface of the sample, and the deflection of the micro cantilever beam is detected. With scanning tunneling microscopes, this is done without contacting the sample, while atomic force microscopes use mechanical interaction with the sample surface.

In scanning tunneling microscopy it is mandatory that the scanning tip of the scanning probe remain separated from the sample. Any contact between the scanning probe and the sample will usually damage the scanning probe to an extent that it is no longer usable. In atomic force microscopy where the scanning tip of the scanning probe contacts the sample surface during the scanning process, the scanning tip is subject to constant wear due to the mechanical interaction. For this reason, both applications require frequent replacement of the scanning probe in the scanning probe microscope. As a rule, this is a difficult process because after every change of the scanning probe, the detection system of the scanning probe microscope must be realigned to the exact position of the scanning tip at the free end of the micro cantilever beam so that the deflection of the beam can be detected.

The application of scanning probe microscopes also poses the problem that after the replacement of the scanning probe the scanning tip must be aligned relative to the sample in such a way that the measurement that was interrupted by the probe replacement process can be continued at the exact spot where it was interrupted. This makes it necessary to align the scanning probe as precisely as possible during its attachment to the scanning head so that the scanning tip resumes its original scanning position with high precision.

Scanning heads of known scanning probe microscopes have a probe holder that permits the simple and quick exchange of worn scanning probes. For this purpose, the probe holder is equipped with a support element for the scanning probe that is secured to the probe holder and has a receptacle for the holding element of the scanning probe. In order to facilitate the alignment of the scanning probe, an attachment guide in form of a U-shaped guide element is frequently provided on that side of the support element of the scanning probe that faces the holding element; while being attached to the support element, the holding element can be guided along this attachment guide until the holding element completely engages the guide element and the scanning probe is aligned relative to the scanning head.

Following the removal and insertion of a scanning probe, guide elements as known in the prior art are not precise enough to continue the measurement at the very same scanning position characterized by the position of the scanning tip prior to the exchange of the scanning probe. It is therefore desirable to design the support element and the scanning probes so that, when the scanning probe is replaced, a reproducibly precise positioning of the scanning tip relative to the scanning head—and therefore also to the sample—is ensured, especially with scanning probes whose micro cantilever beams have different lengths.

Accordingly, there is a strong need in the art for scanning probes for alternative use in a scanning probe microscope where the scanning probes can be exchanged quickly and easily on the probe holder, and that permit the high-precision self-alignment of the scanning probe in conjunction with a support element secured in position on the probe holder in such a way that, independent of the length of the micro cantilever beam, the scanning tip of the scanning probes is positioned automatically with high reproducibility relative to the sample in the course of the exchange.

### SUMMARY OF THE INVENTION

The scanning probes proposed by the invention have micro cantilever beams of different lengths, with the distance between the scanning tip and a defined reference point of the holding element being constant in each case.

For the defined reference point of the holding element, a corresponding reference point on the support element is provided that is located opposite the reference point of the scanning probe when the scanning probe is mounted. In a defined position relative to the first reference point and the corresponding reference point, respectively, alignment elements are provided on the corresponding lateral surfaces of the holding element and of the support element, and these alignment elements align the scanning probe in automatically reproducible fashion when it is coupled with the support element. Here, preferably, the scanning tip that is located at an identical distance from the defined reference point of the holding element in all scanning probes, regardless of the length of the micro cantilever beam, is positioned with high reproducibility relative to the sample to be scanned.

The alignment elements of the support element and of the holding element interact by making positive contact. They may face each other, or may be staggered relative to each other. Depending on their arrangement it is possible to choose a complementary design of the alignment elements, specifically a mirror-image design, or to design only individual and corresponding contact surfaces to have a matching design. The alignment elements may be of recessed and/or raised design, of any cross-sectional shape, and may have the same or different lengths. Preferably, the raised alignment elements are higher than the recessed alignment elements are deep, thereby facilitating the self-alignment.

The precision of the lateral alignment is ensured, for example, by V-shaped ridges on the support element that are arranged perpendicular to each other, and by exactly matching V-shaped grooves on the back side of the scanning probes. The height of the ridges and the depth of the grooves are selected so that the scanning probe coupled with the support element rests only on the ridges, with the V-shape of the alignment elements causing an optimal alignment in all three spatial directions. The alignment elements of the holding element and of the support element interact on the basis of the lock-and-key principle. When the holding element is placed on the support element of the scanning probe and subjected to mechanical contact pressure, the scanning probe is aligned with high reproducibility.

It serves the purpose of providing an attachment guide for the pre-alignment of the scanning probe along the edge of the support element on the sides facing away from the micro cantilever beam, with said guide acting on the scanning probe when it is placed on the support element. During the connecting process, this guide positions the alignment elements of the support element and of the holding element relative to each other in such a way that they can interact when the holding element is lowered onto the support element.

Preferably, with the scanning probes, in each case the distance between the defined reference point of the holding element and a front edge of the holding element associated with the micro cantilever beam is made variable, depending on the length of the micro cantilever beam.

This has the effect that, regardless of the length of the micro cantilever beam, the scanning tip will always be at the exact same distance from the reference point of the holding element, and therefore from the alignment elements of the holding element that are linked to the reference point. This makes it possible to vary the length of the micro cantilever beam without changing the position of the alignment elements of the holding element relative to the scanning tip. Due to the identical distance from the reference point, the scanning tip also will always have the exact same distance from the reference point of the support element, and therefore from the corresponding scanning position of the sample.

Another advantageous embodiment of the invention provides for the scanning probes to have the same length from the scanning tip to a rear edge of the holding element that faces away from the micro cantilever beam.

Accordingly, with all scanning probes, the rear edge of the holding element is located at the same distance from the reference point, and therefore from the alignment elements of the holding element. Due to the identical distance from the reference point, the rear edge—regardless of the length of the micro cantilever beam—has the exact same distance from the reference point of the support element, and therefore also from the alignment elements and from the attachment guide of the support element, so that—even with variations of the length of the micro cantilever beam—the rear edge may serve for the pre-alignment of the scanning probe in the direction of the micro cantilever beam during the connecting process.

According to an aspect of the invention, a combination of scanning probes for alternative use in a scanning probe microscope is provided. The scanning probes have a micro cantilever beam whose one end has a scanning tip for scanning a sample and whose other end has a holding element for the non-permanent attachment of the scanning probe to a support element secured to a probe holder. Corresponding alignment elements are incorporated in the holding element and in the support element that align the holding element in automatically reproducible fashion relative to the probe holder when coupled with the support element, wherein the micro cantilever beams of the scanning probes have different lengths and in each scanning probe the distance between the scanning tip and a defined reference point of the holding element is constant.

According to another aspect, with each of the scanning probes, the distance between the defined reference point of the holding element and a front edge of the holding element that is associated with the micro cantilever beam may vary, depending on the length of the micro cantilever beam.

In still another aspect, the scanning probes have the same length from the scanning tip to a rear edge of the holding element that faces away from the micro cantilever beam.

In accordance with yet another aspect, the corresponding alignment elements interact in complementary physical arrangement.

According to another aspect the corresponding elements include raised alignment elements and recessed alignment elements for receiving the raised alignment elements.

In yet another aspect, the corresponding alignment elements provide alignment in all three spatial directions.

According to still another aspect, a process for manufacturing scanning probes for a scanning probe microscope is provided. The scanning probes have micro cantilever beams of different lengths whose one end has a scanning tip for scanning a sample and whose other end has a holding element for the non-permanent attachment of the scanning probes to a support element secured in position on a probe holder, and where corresponding alignment elements are incorporated in the holding element and in the support element that align the holding element in automatically reproducible fashion relative to the probe holder when coupled with the support element, where the scanning tip of the scanning probe is precisely positioned relative to the probe holder. The method includes the steps of: designing and manufacturing a commonly usable support element with alignment elements for the precision alignment of scanning probes with micro cantilever beams of different lengths; designing the rear part of the holding element opposite the support element while incorporating alignment elements that correspond with the alignment elements of the support element; determining a defined reference point in an area around the alignment elements of the holding element, at a certain constant distance from which the scanning tip is to be arranged when the length of the micro cantilever beam varies; designing the front part of the holding element associated with the micro cantilever beam, with variation of the distance of the front edge facing the scanning tip and the reference point of the holding element until the desired length of the micro cantilever beam is obtained; designing the micro cantilever beam with the scanning tip at its end, with the scanning tip arranged at a certain distance from the reference point of the holding element; and manufacturing the scanning probe.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Below, the invention is explained in detail with reference to an embodiment shown in the drawings. Here, the figures of the drawings and their description reveal additional characteristics and advantages of the invention.

A mechanism is shown that permits a highly precise self-alignment of scanning probes with micro cantilever beams of different lengths for scanning probe microscopy during the exchange of the scanning probes. The mechanism includes two interacting components, the support element that is firmly connected with the scanning head of the scanning probe microscope, and specially adapted scanning probes. Specifically,

FIG. 1 shows a view of a scanning probe coupled to a support element;

FIG. 2 shows a view of the support element and the scanning probe from FIG. 1 in non-coupled condition; and

FIG. 3 shows a comparison of coupled scanning probes in accordance with FIG. 1 with micro cantilever beams of different lengths.

### DETAILED DESCRIPTION OF THE INVENTION

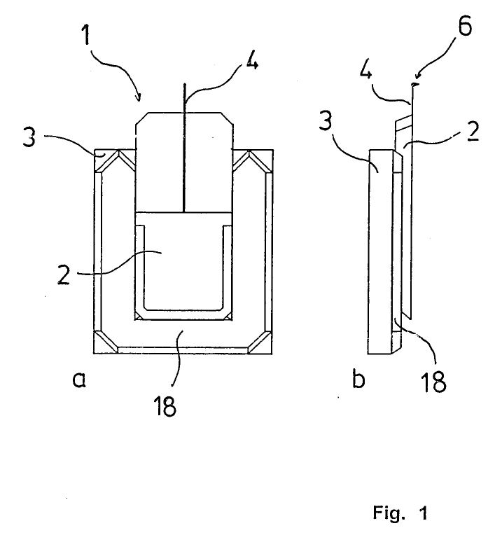

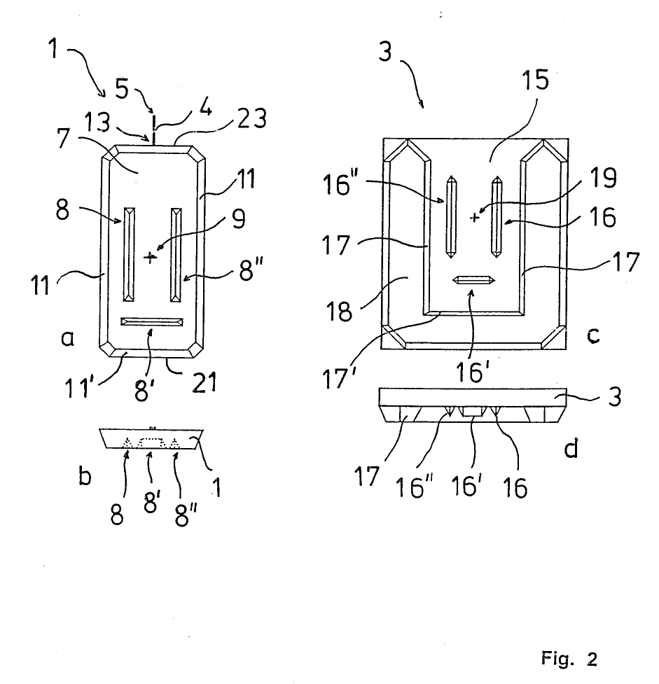

FIG. 1 shows a scanning probe 1 in accordance with the invention whose holding element 2 is coupled with a support element 3 of a probe holder (not shown). Arranged behind the holding element 2, it has a micro cantilever beam 4 at whose one end 5 a scanning tip 6 rises perpendicular to the micro cantilever beam 4, as shown in FIG. 1a. This scanning tip 6 serves to scan a sample (not shown). The support element 3 is secured in position on the probe holder, and the scanning probe 1 is connected non-permanently to the support element 3 via the holding element 2. The support element 3 and the holding element 2 are essentially square and have recesses and raised sections serving as alignment elements 8, 8′, 8″, 16, 16′, 16″, 18, as shown in FIG. 2a to 2d, through which the support element 3 and the holding element 2 act on each other by means of positive contact.

FIGS. 2a, 2b show the scanning probe 1 without the support element 3. On the contact side 7 associated with the support element 3, the holding element 2 has alignment elements 8, 8′, 8″ in the form of recesses with an elongated prismatic shape. Angled surfaces 10, 10′ of the alignment elements 8, 8′, 8″ and inclined lateral surfaces 11, 11′ of the holding element 2 serve as contact surfaces for the support element 3 and cause the automatic alignment of the holding element 2, and therefore of the entire scanning probe 1, when the holding element 2 is coupled with the support element 3.

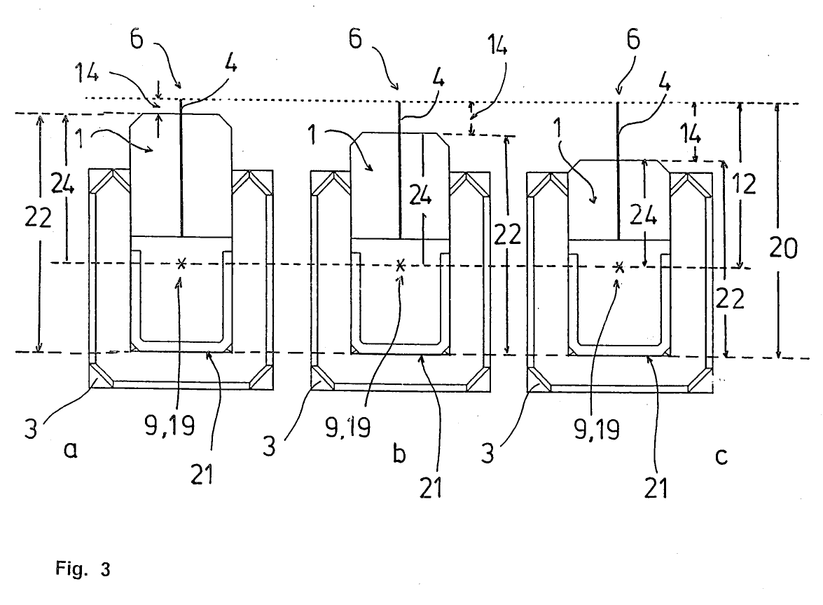

The scanning tip 6 provided at the end 5 of the micro cantilever beam 4 has a constant distance 12 from a predetermined reference point 9 of the holding element 2, that is independent of the length 14 of the micro cantilever beam 4 in each case for all scanning probes shown, as can be seen from FIG. 3.

FIGS. 2c, 2d show the support element 3 in non-coupled condition. From its flat surface 15 associated with the contact surface 7 of the holding element 2, alignment elements 16, 16′, 16″ protrude that act on the alignment elements 8, 8′, 8″ and precisely position the scanning probe 1 when the scanning probe 1 is coupled with the support element 3. For pre-alignment purposes, angled surfaces 17, 17′ of an attachment guide 18 serve in conjunction with the inclined lateral surfaces 11, 11′ of the holding element 2.

The alignment elements 8, 8′, 8″ of the holding element 2 are located centrally relative to a reference point 9 of the holding element 2, and the alignment elements 16, 16′, 16″ of the support element 3 are located centrally relative to a reference point 19 of the support element 3. They show the same distance and the same location relative to their respective reference points 9 and 19. In the coupled condition of the scanning probe 1, the reference point 9 and the reference point 19 face each other so that the alignment elements 8, 8′, 8″ of the holding element 2 and the alignment elements 16, 16′, 16″ of the support element 3 are in alignment with each other. The alignment elements 8, 8′, 8″ and 16, 16′, 16″ are essentially of complementary design, with the alignment elements 8, 8′, 8″ of the holding element 2 having a different length than the alignment elements 16, 16′, 16″ of the support element 3. They engage each other with positive contact, as shown in FIGS. 1a, 1b.

FIG. 3 shows three scanning probes 1 as proposed by the invention with micro cantilever beams 4 of different lengths 14, shown as examples in FIGS. 3a, 3b, and 3c. Here, the scanning tip 6 located at the end 5 of each micro cantilever beam 4 has an identical distance 12 from each reference point 9. The total length 20 of the scanning probe 1 that is determined by the front end 5 of the micro cantilever beam 4 and the rear edge 21 of the holding element 2 is constant in all three examples. The different length 14 of the micro cantilever beam 4 in each case is achieved by the variation of a length 22 of the holding element 2, which has the effect that the front edge 23 of the holding element 2 that follows the rear end 13 of the micro cantilever beam 4 has a different position relative to the reference point 9 of the holding element 2 in each case.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A combination of scanning probes for alternative use in a scanning probe microscope where the scanning probes have a micro cantilever beam whose one end has a scanning tip for scanning a sample and whose other end has a holding element for the non-permanent attachment of the scanning probe to a support element secured to a probe holder, and where corresponding alignment elements are incorporated in the holding element and in the support element that align the holding element in automatically reproducible fashion relative to the probe holder when coupled with the support element, wherein the micro cantilever beams of the scanning probes have different lengths and in each scanning probe the distance between the scanning tip and a defined reference point of the holding element is constant.

2. The combination of scanning probes according to claim 1, wherein with each of the scanning probes, the distance between the defined reference point of the holding element and a front edge of the holding element that is associated with the micro cantilever beam may vary, depending on the length of the micro cantilever beam.

3. The combination of scanning probes according to claim 1, wherein the scanning probes have the same length from the scanning tip to a rear edge of the holding element that faces away from the micro cantilever beam.

4. The combination of scanning probes according to claim 2, wherein the scanning probes have the same length from the scanning tip to a rear edge of the holding element that faces away from the micro cantilever beam.

5. The combination of scanning probes according to claim 1, wherein the corresponding alignment elements interact in complementary physical arrangement.

6. The combination of scanning probes according to claim 5, wherein the corresponding elements comprise raised alignment elements and recessed alignment elements for receiving the raised alignment elements.

7. The combination of scanning probes according to claim 1, wherein the corresponding alignment elements provide alignment in all three spatial directions.

8. A process for manufacturing scanning probes for a scanning probe microscope where the scanning probes have micro cantilever beams of different lengths whose one end has a scanning tip for scanning a sample and whose other end has a holding element for the non-permanent attachment of the scanning probes to a support element secured in position on a probe holder, and where corresponding alignment elements are incorporated in the holding element and in the support element that align the holding element in automatically reproducible fashion relative to the probe holder when coupled with the support element, where the scanning tip of the scanning probe is precisely positioned relative to the probe holder, including the steps of:
(a) designing and manufacturing a commonly usable support element with alignment elements for the precision alignment of scanning probes with micro cantilever beams of different lengths;
(b) designing the rear part of the holding element opposite the support element while incorporating alignment elements that correspond with the alignment elements of the support element;
(c) determining a defined reference point in an area around the alignment elements of the holding element, at a certain constant distance from which the scanning tip is to be arranged when the length of the micro cantilever beam varies;
(d) designing the front part of the holding element associated with the micro cantilever beam, with variation of the distance of the front edge facing the scanning tip and the reference point of the holding element until the desired length of the micro cantilever beam is obtained;
(e) designing the micro cantilever beam with the scanning tip at its end, with the scanning tip arranged at a certain distance from the reference point of the holding element; and
(f) manufacturing the scanning probe.
